(19) United States
(12) Patent Application Publication
(10) Pub. No.: US 2004/0212286 A1
(43) Pub. Date: Oct. 28, 2004

(54) Lamp system with reflector, high pressure discharge lamp, and image projection apparatus

(76) Inventors: Makoto Horiuchi, Nara (JP); Mitsuhiko Kimoto, Nara (JP); Kazuaki Ohkubo, Osaka (JP)

Correspondence Address: HARNESS, DICKEY & PIERCE, P.L.C., P.O. BOX 828, BLOOMFIELD HILLS, MI, 48303, US

(21) Appl. No.: 10/829,973

(22) Filed: Apr. 22, 2004

(30) Foreign Application Priority Data
Apr. 23, 2003 (JP) 2003-118230

(51) Int. Cl. H01J 5/16; H01J 61/40; H01J 17/04; H01J 5/48

(52) U.S. Cl. 313/113; 313/318.11

(57) ABSTRACT

A lamp system with a reflector includes a high pressure discharge lamp and a reflector. The reflector has a first opening located in a forward position of the reflector with respect to a light-emission direction and a second opening into which a sealing portion is inserted. The sealing portion has a first glass portion extending from a luminous bulb and a second glass portion provided in at least a portion inside the first glass portion, and the sealing portion has a portion to which a compressive stress is applied. When the sealing portion is disposed in a substantially horizontal direction, a microcavity is formed in at least a lower portion of the luminous bulb.

### BACKGROUND OF THE INVENTION

The present invention relates to lamp systems with reflectors, high pressure discharge lamps, and image projection apparatuses. In particular, the present invention relates to high pressure mercury lamps, which are used as light sources for projectors or the like, and in which a relatively large amount of mercury is enclosed.

In recent years, image projection apparatuses such as liquid crystal projectors and DMD projectors have been widely used as systems for realizing large-scale video images. As those image-projection apparatuses, high pressure mercury lamps such as disclosed in Japanese Unexamined Patent Publication No. 2-148561 have been commonly used.

FIG. 1 illustrates the structure of a high pressure mercury lamp disclosed in Japanese Unexamined Patent Publication No. 2-148561. The lamp 1000 illustrated in FIG. 1 includes a luminous bulb 1 mainly made of quartz glass and a pair of side tube portions (sealing portions) 2 that extend from both sides of the luminous bulb 1. In each side tube portion 2, an electrode structure made of metal is buried so as to supply power from without into the luminous bulb. In each electrode structure, an electrode 3 made of tungsten (W), a molybdenum (Mo) foil 4, an external lead 5 are electrically connected in sequence. A coil 12 is wound around the tip of each electrode 3. In the luminous bulb 1, mercury (Hg) and argon (Ar) serving as luminous species, and a small amount of halogen gas (not shown) are enclosed.

The operational principle of the lamp 1000 will be briefly described below. When starting voltage is applied across the ends of the pair of external leads 5, discharge of argon (Ar) occurs to increase the temperature in the luminous bulb 1. This temperature rise causes the Hg atoms to evaporate, and the evaporated atoms in gaseous form fill the inside of the luminous bulb 1. The Hg is exited between the electrodes 3 by electrons emitted from one of the electrodes 3, and emits light. Therefore, the higher the vapor pressure of the Hg serving as a luminous species, the higher the intensity of the light emitted. Furthermore, the higher the vapor pressure of the Hg, the greater the potential (voltage) difference between the electrodes. Therefore, when lamps are operated at the same rated power, current in lamps with a higher Hg vapor pressure can be reduced as compared to lamps with a lower Hg vapor pressure. This means that load on the electrodes 3 can be decreased, which leads to a longer life of the lamp. Thus, as the Hg vapor pressure is elevated, the lamp exhibits more excellent properties in terms of its intensity and durability.

However, conventional high pressure mercury lamps have been practically used at an Hg vapor pressure of about 15 to 20 MPa (150 to 200 atm) in view of their physical strength against vapor pressure. Although Japanese Unexamined Patent Publication No. 2-148561 discloses an ultra-high pressure mercury lamp whose Hg vapor pressure is 200 to 350 bars (corresponding to about 20 to 35 MPa), those lamps are operated at an Hg vapor pressure of about 15 to 20 MPa (150 to 200 atm) when put into practical use, in consideration of their reliability and life, for example.

Research and development aiming to enhance lamp strength against vapor pressure have been conducted. Nevertheless, no report has been made to date on a high pressure mercury lamp having high resistance to vapor pressure, which is capable of withstanding an Hg vapor pressure exceeding the 20 MPa level, and which can be used in practice. Under these circumstances, the present inventors successfully developed high pressure mercury lamps having high strength against vapor pressure, capable of withstanding a vapor pressure of about 30 to 40 MPa or more (about 300 to 400 atm or more) as disclosed in U.S. Patent Application Publications Nos. US-2003-0102805-A1 and US-2003-0168980-A1.

Those high pressure mercury lamps having extremely high strength against vapor pressure are operated at a mercury vapor pressure that was not achieved by prior art techniques. For that reason, it is not possible to predict what characteristics and behavior those high pressure mercury lamps will exhibit. The present inventors carried out burning tests of the high pressure mercury lamps, and found that blackening occurs in the lamps when the operating pressure exceeds the conventional limit value, 20 MPa, in particular, about the 30 MPa level.

### SUMMARY OF THE INVENTION

The present invention has been made in view of the foregoing respects, and it is a main object of the present invention to suppress lamp blackening in a high pressure mercury lamp whose operating pressure exceeds 20 MPa (for example, 23 MPa or more, in particular 25 MPa or more (or 27 MPa or more, or 30 MPa or more)) and in a reflector equipped lamp system having such a high pressure mercury lamp.

An inventive lamp system with a reflector includes: a high pressure discharge lamp including a luminous bulb with a luminous substance enclosed therein and a pair of sealing portions extending from the luminous bulb, and a reflector for reflecting light emitted from the high pressure discharge lamp, wherein the reflector has a first opening located in a forward position of the reflector with respect to a light-emission direction, and the reflector is formed with a second opening into which one of the sealing portions is inserted, at least one of the sealing portions has a first glass portion extending from the luminous bulb and a second glass portion provided in at least a portion inside the first glass portion, and the at least one sealing portion has a portion to which a compressive stress is applied, and when the sealing portions are disposed in a substantially horizontal direction, a microcavity is formed in at least a lower portion of the luminous bulb.

The high pressure discharge lamp is preferably a high pressure mercury lamp, and mercury is preferably enclosed as the luminous substance in an amount of 230 mg/cm³ or more based on the internal volume of the luminous bulb.

Another inventive lamp system with a reflector includes: a high pressure mercury lamp including a luminous bulb with at least mercury enclosed therein and a pair of sealing portions extending from the luminous bulb, and a reflector for reflecting light emitted from the high pressure mercury lamp, wherein the reflector has a first opening located in a forward position of the reflector with respect to a light-emission direction, and the reflector is formed with a second opening into which one of the sealing portions is inserted, each of the sealing portions has a first glass portion extending from the luminous bulb and a second glass portion provided in at least a portion inside the first glass portion, and each of the sealing portions has a portion to which a compressive stress is applied, and when the sealing portions are disposed in a substantially horizontal direction, a microcavity, which at least partially blocks infrared radiation emitted outward from inside the luminous bulb, is formed in at least a lower portion of an outer surface of the luminous bulb.

In one preferred embodiment, the portion of the luminous bulb in which the microcavity is formed blocks transmission of infrared radiation, while passing visible light, and the other portion of the luminous bulb in which the microcavity is not formed passes both the infrared radiation and the visible light.

The microcavity may have a diameter of 0.35 μm or greater.

In one preferred embodiment, the microcavity is formed in the lower portion of the luminous bulb and is not formed in an upper portion of the luminous bulb.

In one preferred embodiment, at least mercury is enclosed as the luminous substance, the amount of the enclosed mercury is 270 mg/cm³ or more based on the internal volume of the luminous bulb, halogen is enclosed in the luminous bulb, and the lamp has a bulb wall load of 80 W/cm² or more.

The reflector may be a cold mirror.

In one preferred embodiment, the mercury is enclosed in an amount of 300 mg/cm³ or more based on the internal volume of the luminous bulb.

In one preferred embodiment, a pair of electrode rods are opposed to each other in the luminous bulb, the electrode rods are connected to respective metal foils, and the metals foils are provided in the respective sealing portions, and at least partially positioned in the respective second glass portions.

In one preferred embodiment, a coil at least the surface of which has at least one metal selected from the group consisting of Pt, Ir, Rh, Ru, and Re is wound around at least a part of each of the electrode rods where the electrode rods are buried in the sealing portions.

In one preferred embodiment, a metal portion that is in contact with the second glass portion and supplies power is provided in each of the sealing portions, the compressive stress is applied in at least a longitudinal direction of the sealing portions, the first glass portion contains 99 wt % or more of SiO₂, and the second glass portion contains SiO₂ and at least one of 15 wt % or less of Al₂O₃ and 4 wt % or less of B.

In one preferred embodiment, when the sealing portions are measured by a sensitive color plate method utilizing the photoelastic effect, the compressive stress in a region corresponding to the second glass portion is from 10 kgf/cm² to 50 kgf/cm² inclusive.

Still another inventive lamp system with a reflector includes: a high pressure mercury lamp including a luminous bulb with at least mercury enclosed therein and a pair of sealing portions extending from the luminous bulb, and a reflector for reflecting light emitted from the high pressure mercury lamp, wherein the reflector has an opening located in a forward position of the reflector with respect to a light-emitting direction, in the luminous bulb of the high pressure mercury lamp, the mercury is enclosed in an amount of 230 mg/cm³ or more based on the internal volume of the luminous bulb, the high pressure mercury lamp has a bulb wall load of 80 W/cm² or more, and when the sealing portions are disposed in a substantially horizontal direction, a microcavity is formed in at least a lower portion of the luminous bulb.

An inventive high pressure discharge lamp includes: a luminous bulb, in which at least mercury is enclosed, and a sealing portion extending from the luminous bulb, wherein the mercury is enclosed in the luminous bulb in an amount of 230 mg/cm³ or more based on the internal volume of the luminous bulb, and a microcavity is formed in at least a portion of the luminous bulb.

Another inventive lamp system with a reflector includes: a luminous bulb, in which at least mercury is enclosed, and a pair of sealing portions extending from the luminous bulb, wherein each of the sealing portions has a first glass portion extending from the luminous bulb and a second glass portion provided in at least a portion inside the first glass portion, and each of the sealing portions has a portion to which a compressive stress is applied, and a microcavity, which at least partially blocks infrared radiation emitted outward from inside the luminous bulb, is formed in at least a portion of an outer surface of the luminous bulb.

An inventive image projection apparatus includes: the above-mentioned reflector-equipped lamp system and an optical system in which the reflector-equipped lamp system is used as a light source.

A high pressure mercury lamp in one embodiment includes a luminous bulb within which a pair of electrodes are opposed, and a sealing portion which extends from the luminous bulb and within which a portion of the electrode is contained. A metal film made of at least one metal selected from the group consisting of Pt, Ir, Rh, Ru, and Re is formed on at least part of the surface of the portion of the electrode positioned in the sealing portion.

In one embodiment, the electrode is connected by welding to a metal foil provided in the sealing portion, and the metal film is formed not on the connection point to the metal foil but on the surface of the portion of the electrode embedded in the sealing portion. A portion of the metal forming the metal film may be present within the luminous bulb. The metal film preferably has a multilayer structure in which the lower layer is an Au layer and the upper layer is a Pt layer.

A high pressure mercury lamp in one embodiment includes a luminous bulb within which a pair of electrodes are opposed and a sealing portion which extends from the luminous bulb and within which a portion of the electrode is contained. A coil whose surface contains at least one metal selected from the group consisting of Pt, Ir, Rh, Ru, and Re is wound around the portion of the electrode positioned in the sealing portion. In one embodiment, portions of the metal foil and the electrode are embedded in the sealing portion, and a coil whose surface contains at least one metal selected from the group consisting of Pt, Ir, Rh, Ru, and Re is wound around the portion of the electrode embedded in the sealing portion. The surface of the coil preferably has a metal film of a multilayer structure in which the lower layer is an Au layer and the upper layer is a Pt layer.

A high pressure mercury lamp in one embodiment includes a luminous bulb with a luminous substance enclosed therein and a sealing portion for retaining the airtightness of the luminous bulb. The sealing portion includes a first glass portion extending from the luminous bulb and a second glass portion provided in at least a portion of the inside of the first glass portion, and the sealing portion has a portion to which a compressive stress is applied. The portion to which a compressive stress is applied is selected from the group consisting of the second glass portion, the boundary portion between the second glass portion and the first glass portion, a portion of the second glass portion closer to the first glass portion, and a portion of the first glass portion closer to the second glass portion. In one embodiment, a strain boundary region produced by a difference in compressive stress between the first glass portion and the second glass portion is present in the vicinity of the boundary between the two glass portions. A metal portion which comes into contact with the second glass portion and which is used for supply of power is preferably provided within the sealing portion. The compressive stress need only be applied in at least the longitudinal direction of the sealing portion.

In one embodiment, the first glass portion contains 99 wt % or more of SiO₂, the second glass portion contains SiO₂ and at least one of 15 wt % or less of Al₂O₃ and 4 wt % or less of B, and the second glass portion has a lower softening point than the first glass portion. It is preferable that the second glass portion be a glass portion formed from a glass tube. Moreover, it is preferable that the second glass portion be not a glass portion formed by compressing glass powder and sintering the compressed material. In one embodiment, in the portion to which a compressive stress is applied, the stress value is from about 10 kgf/cm² to about 50 kgf/cm², or the difference in the compressive stress between the two portions is from about 10 kgf/cm² to about 50 kgf/cm².

In one embodiment, in the luminous bulb, a pair of electrode rods are opposed to each other. At least one of the pair of electrode rods is connected to a metal foil. The metal foil is provided in the sealing portion and at least a portion of the metal foil is positioned in the second glass portion. As the luminous substance, at least mercury is enclosed in the luminous bulb. The amount of the enclosed mercury is 300 mg/cc or more. The high pressure mercury lamp has an average color rendering index Ra above 65. The high pressure mercury lamp preferably has a color temperature of 8000 K or greater.

### BRIEF DESCRIPTION OF THE DRAWINGS

FIG. 1 is a schematic view illustrating the structure of a conventional high pressure mercury lamp 1000.

FIGS. 2A and 2B are schematic views illustrating the structure of a high pressure discharge lamp 1100.

FIG. 3 is a schematic view illustrating the structure of a high pressure discharge lamp 1200.

FIG. 4 is a schematic view illustrating the structure of a high pressure discharge lamp 1300.

FIG. 5A is a schematic view illustrating the structure of a high pressure discharge lamp 1400, while FIG. 5B is a schematic view illustrating the structure of a high pressure discharge lamp 1500.

FIG. 6 is a cross sectional view schematically illustrating the structure of a lamp system 500 with a reflector in accordance with a first embodiment of the present invention.

FIG. 7 is a magnified view schematically illustrating a main part in which microcavities 71 are formed.

FIG. 8 is a magnified view schematically illustrating the main part in which the microcavities 71 are formed.

FIG. 9 is a view indicating the optical spectra of lamps having operating pressures of 20 MPa and 40 MPa.

FIG. 10 is a cross sectional view schematically illustrating the structure of a lamp system 600 with a reflector in accordance with a second embodiment of the present invention.

FIGS. 11A and 11B are views for explaining the principle of strain measurement by a sensitive color plate method utilizing photoelastic effect.

FIGS. 12A through 12D are cross sectional views for explaining a mechanism by which compressive stress is applied through annealing process.

FIG. 13A is a schematic view illustrating longitudinal-direction compressive stress present in a second glass portion, while FIG. 13B is a cross sectional view taken along the line A—A in FIG. 13A.

FIG. 14 is a graph schematically indicating the profile of a heating process (an annealing process).

FIG. 15 is a schematic view for explaining a mechanism by which compressive stress is generated in the second glass portion by mercury vapor.

### DETAILED DESCRIPTION OF THE PREFERRED EMBODIMENTS

Hereinafter, embodiments of the present invention will be described in detail with reference to the accompanying drawings.

Prior to describing embodiments of the present invention, a description will first be made of high pressure mercury lamps exhibiting an extremely high strength against pressure, which have an operating pressure of from about 30 to 40 MPa or higher (about 300 to 400 atm or higher). The details of these high pressure mercury lamps are disclosed in U.S Patent Application Publication Nos. 2003-0102805-A1 and 2003-0168980-A1, which are incorporated herein for reference purposes.

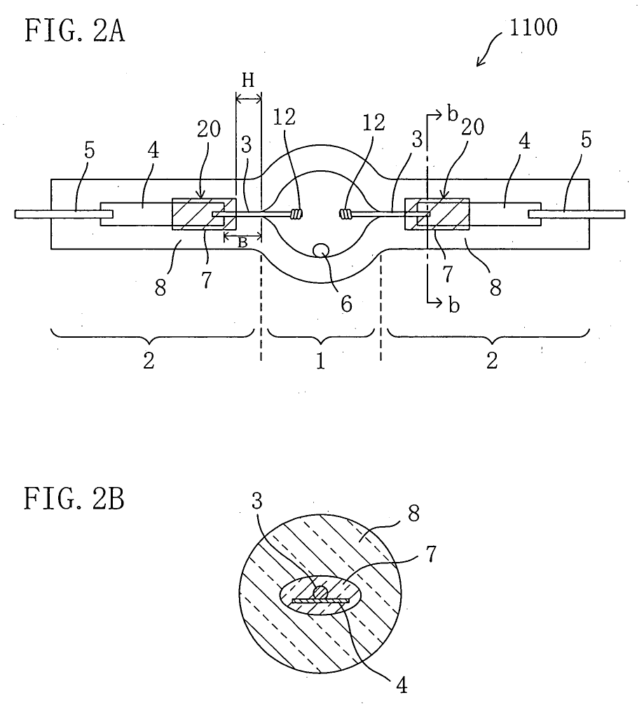

It required very tough work to develop a practically usable high pressure mercury lamp with an operating pressure of about 30 MPa or higher. However, for example, by employing a structure illustrated in FIG. 2, the inventors successfully attained an ultra-high pressure lamp. FIG. 2B is a cross-sectional view taken along the line b—b in FIG. 2A.

A high pressure mercury lamp 1100 illustrated in FIG. 2 is disclosed in the above-mentioned patent application publications. The lamp 1100 includes a luminous bulb 1 and a pair of sealing portions 2 for maintaining the airtightness of the luminous bulb 1. At least one of the sealing portions 2 includes a first glass portion 8 that extends from the luminous bulb 1 and a second glass portion 7 provided in at least a portion inside the first glass portion 8. The one sealing portion 2 has a portion (20) to which compressive stress is applied.

The first glass portion 8 in the sealing portion 2, which contains 99 wt % or more of SiO₂, is made of quartz glass, for example. On the other hand, the second glass portion 7, which contains SiO₂ and at least one of 15 wt % or less of Al₂O₃ and 4 wt % or less of B (wherein SiO₂ accounts for less than 99 wt %), is made of Vycor glass, for example. When Al₂O₃ or B is added to SiO₂, the softening point of the resultant glass is decreased. This means that the softening point of the second glass portion 7 is lower than that of the first glass portion 8. Vycor glass (trade name) is obtained by mixing additives into quartz glass to decrease the softening point, and hence has an improved processability over quartz glass. An exemplary composition of Vycor glass is as follows: 96.5 wt % of silica (SiO₂); 0.5 wt % of alumina (Al₂O₃); and 3 wt % of boron (B). In this embodiment, the second glass portion 7 is formed of a glass tube made of Vycor glass. In stead of the glass tube made of Vycor glass, a glass tube containing 62 wt % of SiO₂, 13.8 wt % of Al₂O₃, and 23.7 wt % of CuO may be used.

The compressive stress applied to the portion of the sealing portion 2 functions effectively, if the stress is substantially beyond zero (i.e., 0 kgf/cm²). The presence of the compressive stress allows the lamp 1100 to have higher strength against pressure than lamps with the conventional structure. It is preferable that the compressive stress be not less than about 10 kgf/cm² (about 9.8×10⁵ N/m²) and not greater than about 50 kgf/cm² (about 4.9×10⁶ N/m²). When the compressive stress is less than 10 kgf/cm², the resultant compressive strain is so weak that the strength of the lamp against pressure may not be increased sufficiently. On the other hand, a structure having a compressive stress exceeding 50 kgf/cm² cannot be realized, because there is no practical glass material available to do so. It should be, however, noted that even a compressive stress of less than 10 kgf/cm² can increase the strength against pressure as compared to the conventional structure, as long as the compressive stress substantially exceeds zero. Furthermore, if a practical material that can realize a structure having a compressive stress of more than 50 kgf/cm² is developed, the second glass portion 7 may have a compressive stress of more than 50 kgf/cm².

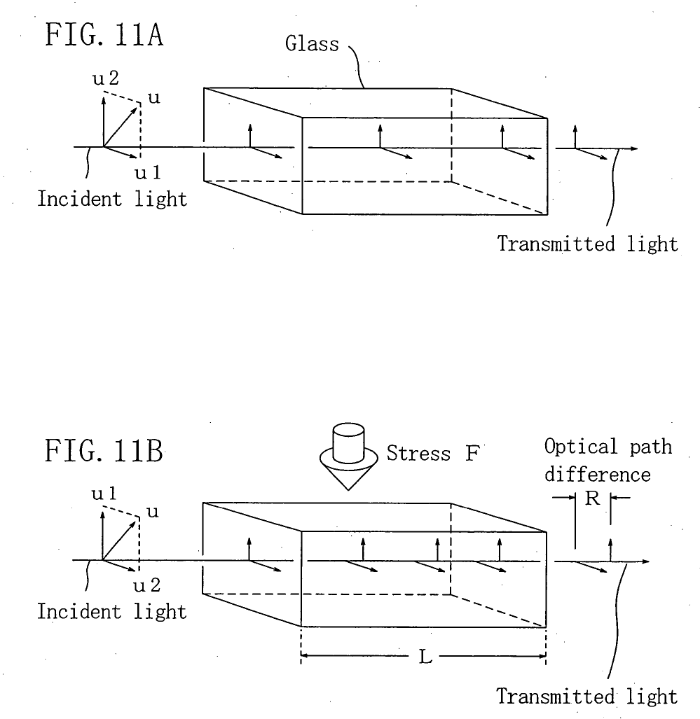

The principle of strain measurement by a sensitive color plate method utilizing photoelastic effect will be described briefly with reference to FIG. 11. FIGS. 11A and 11B are each schematic views showing the state in which linearly polarized light obtained by transmitting light through a polarizing plate is incident to glass. Herein, when the incident linearly polarized light is u, the light u can be regarded as being obtained by synthesizing linearly polarized lights u1 and u2 that intersect at right angles.

As shown in FIG. 11A, when there is no strain in the glass, the respective lights u1 and u2 are transmitted through the glass at the same speed, such that no discrepancy occurs between the lights u1 and u2 after the lights u1 and u2 have been transmitted through the glass. On the other hand, as shown in FIG. 11B, if there is a strain in the glass and a stress F is applied thereto, the lights u1 and u2 are transmitted through the glass at different speeds, such that a discrepancy is produced between the lights u1 and u2 after the lights u1 and u2 have been transmitted through the glass. Specifically, one of the lights u1 and u2 lags behind the other. The lag caused by this delay is referred to as the optical path difference. Since the optical path difference R is proportional to the stress F and the glass transmission distance L, the optical path difference R can be expressed as

R=C·F·L

where C is a proportional constant. The respective units of the marks are as follows: R (nm); F (kgf/cm²); L (cm); and C ({nm/cm}/{kgf/cm²}). The constant C is determined by the quality of the glass and other materials and referred to as a “photoelastic constant”. As can be seen from the above equation, if C is known, F can be obtained by measuring L and R.

The inventors measured the light transmission distance L in the sealing portion 2, that is, the outer diameter L of the sealing portion 2, and then obtained the optical path difference R by observing the color of the sealing portion 2 at the time of the measurement by using a strain standard. As the photoelastic constant C, the photoelastic constant of quartz glass, which is 3.5, was used. These values were substituted in the above equation to calculate the stress value, and the compressive strain in the longitudinal direction of the metal foil 4 is quantified based on the calculated stress value.

In this measurement, the stress in the longitudinal direction (direction in which the electrode rod 3 extends) of the sealing portion 2 was observed, which however does not mean that there is no compressive stress in the other directions. In order to determine whether or not compressive stress is present in the radial direction (the direction from the central axis toward the outer circumference, or the opposite direction), or in the circumferential direction (e.g., the clockwise direction) of the sealing portion 2, the luminous bulb 1 or the sealing portion 2 have to be cut. However, once such cutting is performed, the compressive stress in the second glass portion 7 is released quickly. Therefore, only the compressive stress in the longitudinal direction of the sealing portion 2 can be measured without cutting the lamp 1100. Therefore, the inventors quantified the compressive stress at least in that direction.

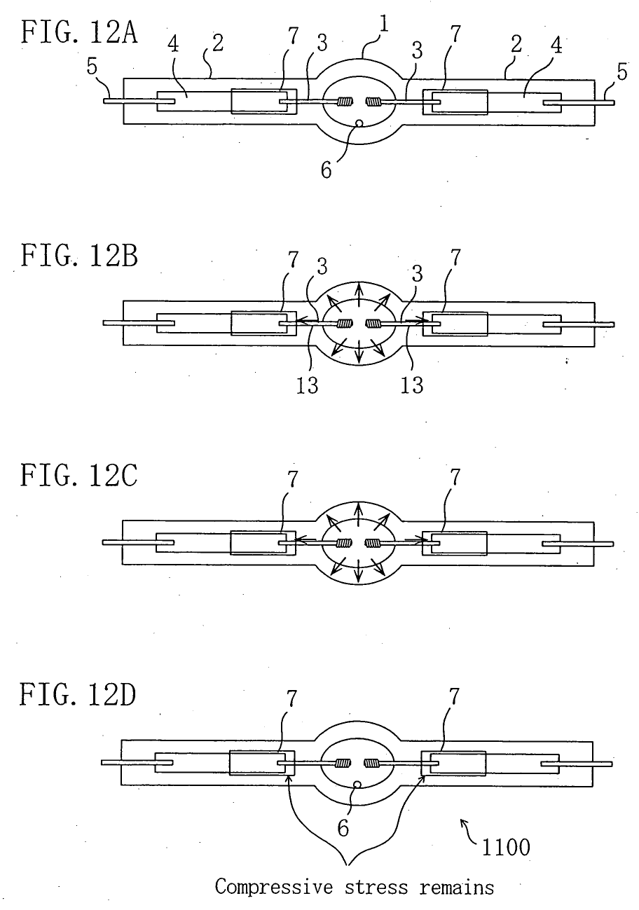

Next, the mechanism inferred by the inventors, i.e., the mechanism by which compressive stress is applied to the second glass portions 7 of the lamp as a result of annealing performed on the lamp assembly at a predetermined temperature for a predetermined period of time or longer, will be described with reference to FIG. 12.

First, as shown in FIG. 12A, a lamp assembly is prepared. The lamp assembly is manufactured in the manner described in the above-mentioned patent applications.

Next, when the lamp assembly is heated, as shown in FIG. 12B, mercury (Hg) 6 starts to evaporate, causing pressure to be applied to the inside of the luminous bulb 1 and to the second glass portions 7. The arrows shown in FIG. 12B indicate the pressure (e.g., 100 atm or more) created by the vapor of the mercury 6. The vapor pressure of the mercury 6 is applied not only to the inside of the luminous bulb 1 but also to the second glass portions 7, because there are gaps 13 that cannot be recognized by human eyes in the sealed portions of the electrode rods 3.

The heating temperature is further increased to exceed the strain point of the second glass portions 7 (e.g., 1030° C.), and the heating of the lamp assembly is continued at that raised temperature. This allows the vapor pressure of the mercury to be applied to the second glass portions 7 that are in a soft state, so that compressive stress is generated in the second glass portions 7. It is estimated that such compressive stress is generated in about 4 hours when the lamp is heated at the strain point, and in about 15 minutes when the lamp is heated at the annealing point, for example. These times are derived from the definitions of the strain point and the annealing point. More specifically, the strain point refers to a temperature at which if the lamp is held for 4 hours, internal strain therein is substantially removed. The annealing point refers to a temperature at which if the lamp is held for 15 minutes, internal stress therein is substantially removed. The above estimated periods of time are derived from these facts.

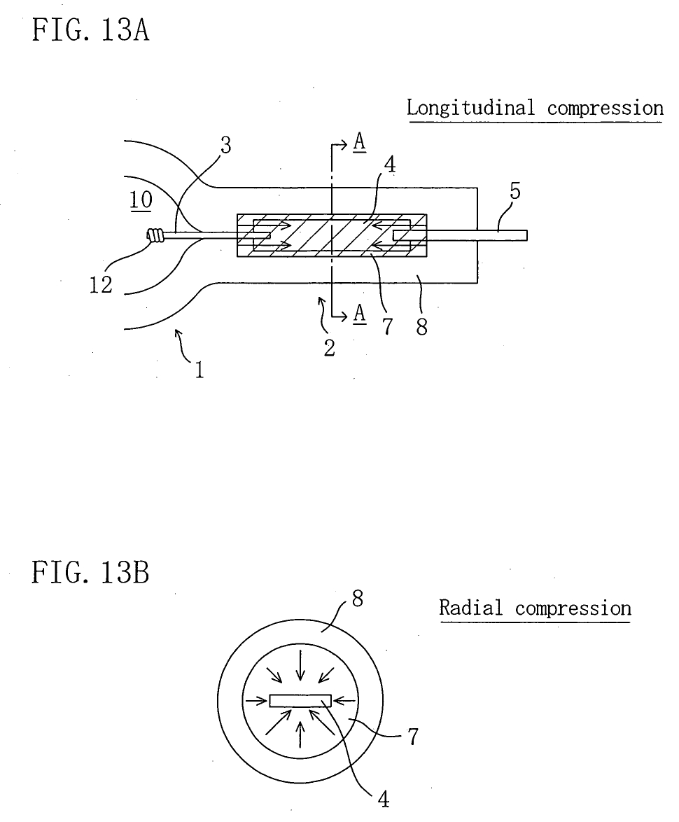

Next, the heating is stopped, so that the lamp assembly is cooled. Even after the heating is stopped, as shown in FIG. 12C, the mercury continues to evaporate. Therefore, while the second glass portions 7 are continuously subjected to the pressure created by the mercury vapor, the temperature of the second glass portions 7 is decreased below the strain point. Consequently, as shown in FIGS. 13A and 13B, the compressive stress not only in the longitudinal direction but also in the radial and other directions of the metal foils 4 remains in the second glass portions 7 (however, only the longitudinal-direction compressive stress can be observed with the strain detector.)

Finally, when the temperature of the lamp assembly is decreased to about room temperature, as shown in FIG. 12D, a lamp 1100 is obtained in which a compressive stress of about 10 kgf/cm² or more is present in the second glass portions 7. As shown in FIGS. 12B and 12C, the mercury vapor pressure causes pressure to be applied to both the second glass portions 7. This method thus ensures that a compressive stress of about 10 kgf/cm² or more is applied to both the sealing portions 2.

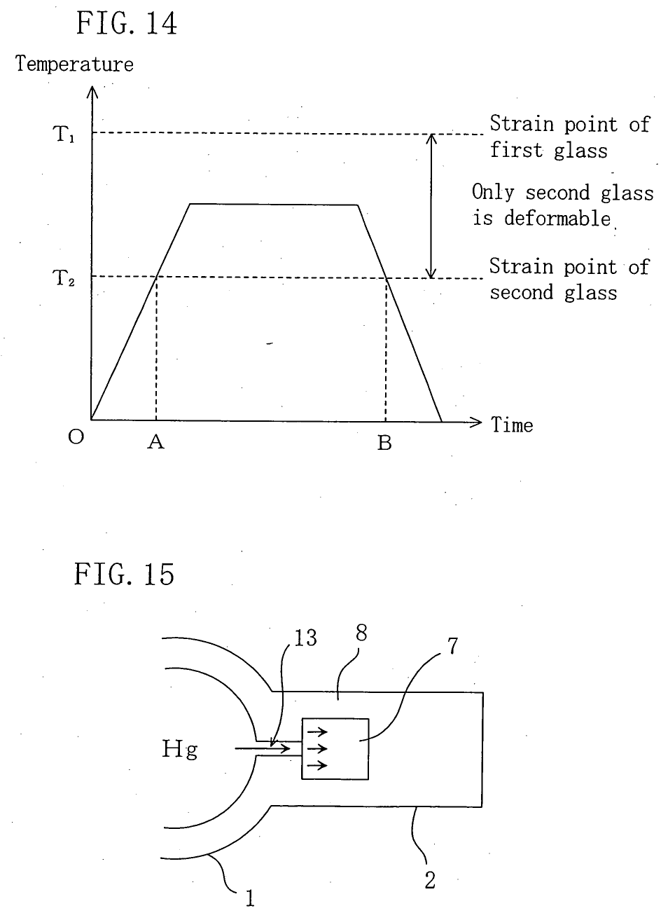

FIG. 14 schematically shows the profile of this heating process. First, the heating is started (at time O), and then the temperature reaches the strain point (T₂) of the second glass portions 7 (at time A). Then, the lamp is held at a temperature between the strain point (T₂) of the second glass portions 7 and the strain point (T₁) of the first glass portions 8 for a predetermined period of time. This temperature range can be basically regarded as a range in which only the second glass portions 7 can be deformed. During the time that the lamp assembly is held at this temperature, compressive stress is produced in the second glass portions 7 by the mercury vapor pressure (e.g., 100 atm or more) as shown in a schematic view in FIG. 15.

It is considered that pressure application to the second glass portions 7 using the mercury vapor pressure is the most effective way to utilize the annealing treatment. It can be inferred, however, that if some force can be applied to the second glass portions 7 while the lamp is held at a temperature in the range between T₂ and T₁ shown in FIG. 14, not only the mercury vapor but also that force (e.g., pushing the external leads 5) can be used to apply compressive stress to the second glass portions 7.

Next, when the heating is stopped, the lamp is gradually cooled so that the temperature of the second glass portions 7 becomes lower than the strain point (T₂) after the passage of time B. When the temperature decreases below the strain point (T₂), the compressive stress in the second glass portions 7 remains. In this embodiment, after the lamp has been held at 1030° C. for 150 hours, it is cooled (naturally cooled). In this way, a compressive stress is generated and remains in the second glass portions 7.

By the above-described mechanism, a compressive stress is generated by the mercury vapor pressure, such that the magnitude of the compressive stress depends on the mercury vapor pressure (in other words, the amount of mercury enclosed).

In general, lamps tend to more readily break easily as the amount of mercury enclosed is increased. However, in a lamp in which the sealing structure of this embodiment is used, as the mercury amount is increased, the compressive stress is increased, and hence the vapor pressure resistance is improved. That is to say, with the structure of this embodiment, a larger mercury amount realizes a higher vapor pressure resistance structure. This provides stable lamp operation at very high operating pressure that the existing techniques could not realize.

Electrode rods 3, each having an end portion positioned in a discharge space, are connected, by welding, to respective metal foils 4 provided in the sealing portions 2. At least part of each metal foil 4 is positioned in the corresponding second glass portion 7. It is sufficient that each metal foil 4 be covered at least partially by the corresponding second glass portion 7. In this embodiment, as shown in FIG. 13B, in a transverse cross section of the sealing portion 2 (a cross section of the sealing portion 2 intersecting perpendicularly to the longitudinal direction thereof), the entire periphery of the metal foil 4 is covered with the second glass portion 7. In other words, the entire widthwise periphery of at least a portion of each metal foil 4 is covered with the corresponding second glass portion 7. In that covered portion, the edge portion of the metal foil 4 is covered with the second glass portion 7. This sufficiently ensures the airtightness. In the structure shown in FIG. 2, the respective second glass portion 7 covers a portion that includes the connection portion of the electrode rod 3 and the metal foil 4. Exemplary dimensions of the second glass portion 7 in the structure shown in FIG. 2 are as follows. The length in the longitudinal direction of the sealing portion 2 is from about 2 to 20 mm (e.g., 3 mm, 5 mm or 7 mm), and the thickness of the second glass portion 7 interposed between the first glass portion 8 and the metal foil 4 is from about 0.01 to 2 mm (e.g., 0.1 mm). The distance H extending from the end face of the second glass portion 7 located closer to the luminous bulb 1 to the discharge space 10 in the luminous bulb 1 is for example from 0 mm to about 3 mm. The distance B extending from the end face of the metal foil 4 located closer to the luminous bulb 1 to the discharge space 10 in the luminous bulb 1 (in other words, the length of the portion of the electrode rod 3 that is buried alone in the sealing portion 2) is, for example, about 3 mm.

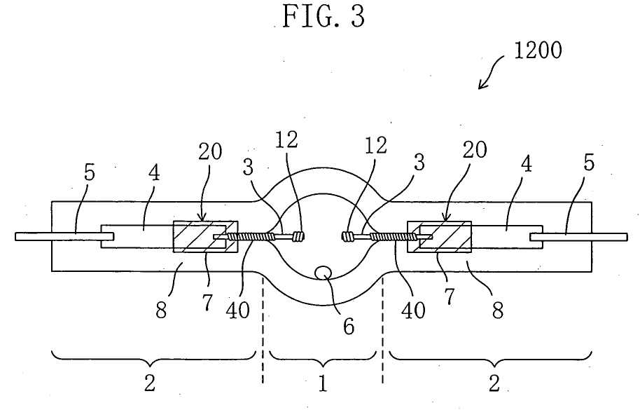

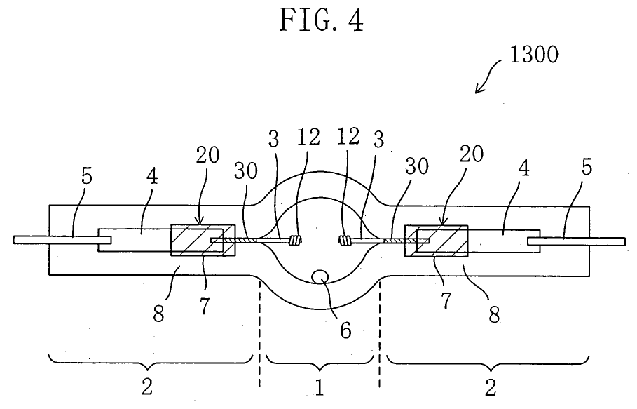

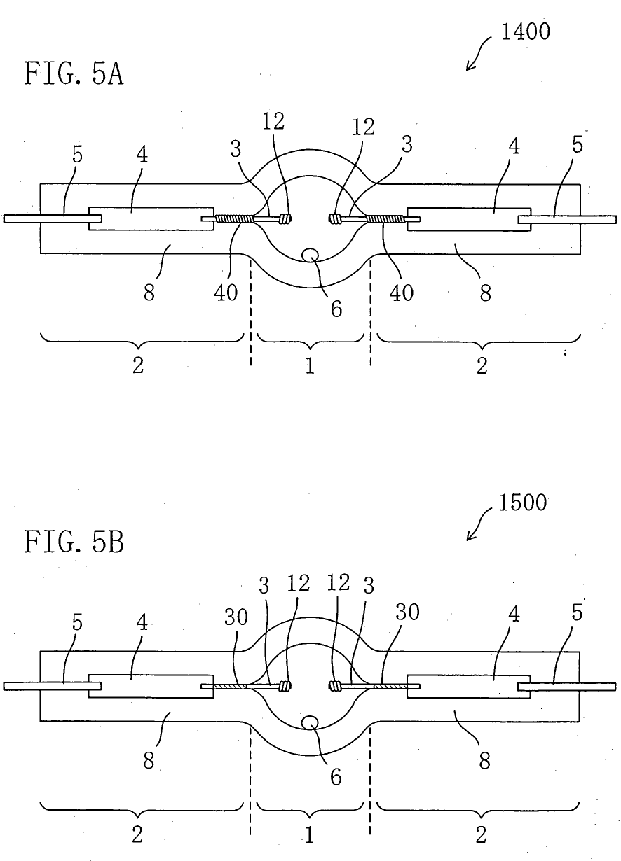

The lamp 1100 shown in FIG. 2 can be modified as shown in FIG. 3. In a high pressure mercury lamp 1200 shown in FIG. 3, a coil 40 whose surface has at least one metal selected from the group consisting of Pt, Ir, Rh, Ru, and Re is wound around each electrode rod 3 where the electrode rod 3 is located in the corresponding sealing portion 2. The respective surfaces of the coils 40 typically have a metal film which has a multilayer structure composed of an Au layer serving as the lower layer and a Pt layer serving as the upper layer. As in a high pressure mercury lamp 1300 illustrated in FIG. 4, instead of each coil 40, a metal film 30 made of at least one metal selected from the group consisting of Pt, Ir, Rh, Ru, and Re may be formed on at least part of the surface of the electrode 3 where the electrode 3 is located in the corresponding sealing portion 2, which may be somewhat a disadvantage in production process in mass production. High pressure mercury lamps 1400 and 1500, which have structures that do not use the second glass portions 7 and employ the coils 40 and the metal films 30, respectively, as shown in FIGS. 5A and 5B, can also realize an operating pressure of 30 MPa or more at a level at which the lamps can be operated practically, although their pressure resistance is lower than that of the structures shown in FIGS. 2 to 4. Nevertheless, in order to achieve more reliable operation, it is preferable that the second glass portions 7, to which a compressive stress of, e.g., about 10 kgf/cm² or more is applied, be present (see the structures in FIGS. 2 to 4.)

The present inventors experimentally produced a lamp such as shown in FIG. 2 in which the Hg vapor pressure during burning exceeds 30 MPa (300 atm), and made a burning test of the lamp. As a result, it was found that when the operating pressure of the lamp reached about 30 MPa or more, the lamp became blackened. Blackening is a phenomenon which occurs when the temperature of the W electrodes 3 is increased during burning to cause W (tungsten) to evaporate from the W electrodes and then attach onto the inner wall of the luminous bulb. If the lamp is continued to be operated in this state, it will break.

When the lamp is operated at a conventional operating pressure of about 15 to 20 MPa (150 to 200 atm), the halogen gas enclosed in the luminous bulb reacts with the tungsten attached onto the inner wall of the luminous bulb and is converted into tungsten halide. The tungsten halide floats in the luminous bulb, and when the tungsten halide reaches the heads 7 of the W electrodes at a high temperature, the tungsten halide is dissociated into the original halogen and tungsten, thereby allowing the tungsten to return to the electrode heads 7. This is called a halogen cycle. Owing to this cycle, lamps employing the conventional Hg vapor pressure can be operated without being blackened. However, the present inventors have found from their experiments that when the operating pressure exceeds 30 MPa (300 atm), this cycle does not work well. Although blackening becomes significant at 30 MPa or more, it is necessary to take measures against the blackening problem for not only lamps operated at 30 MPa or more but also for lamps operated at the level exceeding 20 MPa (for example, the level of 23 MPa or more, or 25 MPa or more) in order to enhance the reliability in practical use.

The present inventors suspected that the thermal design of the high pressure discharge lamp or the reflector-equipped lamp system led to the blackening, and found that the blackening problem would be solved by doing over again the thermal design for an operating pressure of 30 MPa or higher considering from a view point different from the prior art common-sense ways, whereby they have achieved the present invention. Hereinafter, embodiments of the present invention will be described with reference to the accompanying drawings. However, the present invention is not limited to the following embodiments.

(First Embodiment)

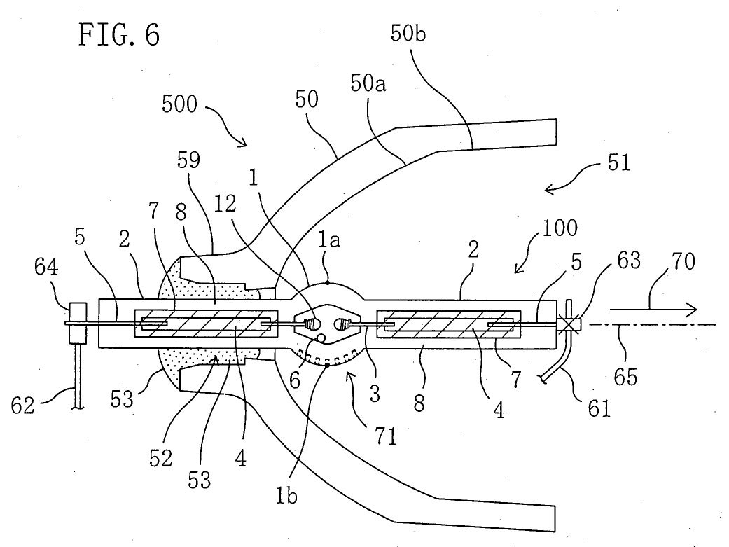

An embodiment of the present invention will be described with reference to the accompanying drawings. FIG. 6 illustrates a cross sectional structure of a lamp system 500 with a reflector in accordance with this embodiment. For ease of viewing, hatching of the cross section is omitted from the figure.

The reflector-equipped lamp system 500 illustrated in FIG. 6 includes a high pressure discharge lamp 100 and a reflector 50 for reflecting light emitted from the lamp 100.

The reflector 50 has a first opening (a wide opening) 51 located in a forward position of the reflector 50 with respect to a light emission direction 70. The reflector-equipped lamp system 500 emits light through the first opening 51. In a rear portion of the reflector 50 (a backward portion thereof with respect to the light emission direction 70) which is located in the center thereof when the reflector 50 is viewed from the front, a neck portion 59 is provided. The neck portion 59 is formed with a second opening (a narrow opening) 52. A sealing portion 2 is inserted into the second opening 52 to secure the lamp 100 and the reflector 50 to each other. The gap between the sealing portion 2 and the second opening 52 is filled with an adhesive 53, which is for example an inorganic adherent (such as cement).

The high pressure discharge lamp 100 is a high pressure mercury lamp 100, in which mercury 6 is enclosed in an amount of for example 230 mg/cm³ or more. The high pressure discharge lamp 100 is similar to the lamp 1100 illustrated in FIG. 2, but differs from the lamp 1100 in that microcavities 71 are formed in at least part of a luminous bulb 1 as shown in FIG. 6. In this embodiment, when the pair of sealing portions 2, 2 are disposed in substantially the horizontal direction, the microcavities 71 are formed in the lower part of the luminous bulb 1. In other respects, the high pressure discharge lamp 100 illustrated in FIG. 6 and the lamp 1100 illustrated in FIG. 2 basically have the same structure. In the lamp 1100 illustrated in FIG. 2, the second glass portions 7 partially cover the respective metal foils 4, but FIG. 6 illustrates the structure in which the second glass portions 7 completely cover the respective metal foils 4. It should be noted that the high pressure mercury lamps 1100 through 1500 illustrated in FIGS. 2 through 5A and 5B may be formed with the microcavities 71 and used as the high pressure mercury lamp 100.

The microcavities 71, which are cavities of a diameter half of a predetermined wavelength, act as waveguides and function to confine light with a wavelength equal to or greater than the predetermined wavelength. Therefore, to block transmission of infrared radiation but to pass visible light (and ultraviolet radiation), the microcavities 71 may be formed having a diameter (size) which is half of the wavelength of the infrared radiation that should be blocked. Then, light with a wavelength grater than twice the diameter of the microcavities 71 will be blocked, while light having a wavelength less than twice will pass without being blocked.

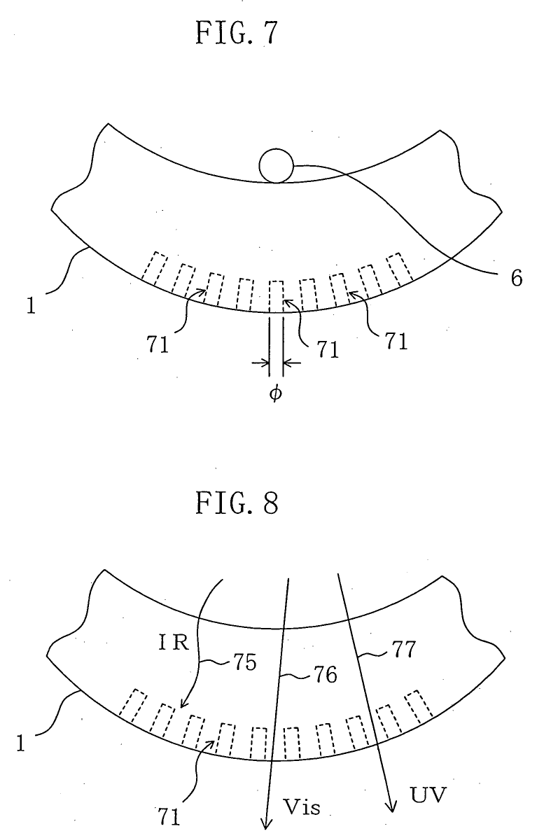

FIG. 7 illustrates a magnified view of the portion in which the microcavities 71 are formed. In this embodiment, the microcavities 71 have a diameter φ of for example 0.35 μm or greater so as to block transmission of infrared radiation but to pass visible light. It is sufficient if the depth of the microcavities 71 is at least twice the diameter, and the depth thus may be about 0.8 to 10 μm, for example. In this embodiment, the depth of the microcavities 71 is 2 μm. When such microcavities 71 are formed, infrared radiation 75, which is blocked by the microcavities 71, cannot pass, while visible light 76 and ultraviolet radiation 77, which are not blocked by the micro cavities 71, are allowed to pass, as shown in FIG. 8.

The microcavities 71 may be formed by digging holes in the outer surface of the luminous bulb (quartz glass) 1 with, e.g., a femto-second laser beam. In this embodiment, the microcavities 71 are formed in the shape of an approximate cylinder having a diameter of 0.5 μm by using a femto-second laser beam. It is technically feasible to form the microcavities 71 at diameters down to the 0.1 μm level. Effects can be attained, even if the cavities are formed by a simpler method, that is, by so-called sandblast, in which the surface is processed by spraying metal, sand and glass particles, for example. Nevertheless, cavities that are processed using a femto-second laser beam have a sharper shape, which results in a higher accuracy in blocking infrared radiation.

In this embodiment, in order to increase the temperature of the lower portion 1b of the luminous bulb 1, the microcavities 71 that block at least part (or all) of the infrared radiation are formed in at least the lower portion 1b (or only in the lower portion 1b) of the luminous bulb 1. In this embodiment, the lower portion 1b of the luminous bulb 1 is an area that includes at least the lowermost point. More specifically, the lower portion 1b is in the vicinity of a lower portion where a vertical axis which passes through the mid point of a virtual axis connecting between the tips of the pair of electrodes and which is perpendicular to the virtual axis in FIG. 6, for example, passes. In this embodiment, “the area including at least the lowermost point” is for example an area located under the horizontal line (or under the plane that includes the electrode-tip-connecting virtual axis) in the luminous bulb 1. In this embodiment, the microcavities 71 are formed only in the lower portion 1b of the luminous bulb 1, and are not formed in an upper portion 1a of the luminous bulb 1. Reasons why the temperature of the lower portion 1b of the luminous bulb 1 is desired to be increased will be described later.

The structure of the high pressure mercury lamp 100 illustrated in FIG. 6 will be further described. Like the structure illustrated in FIG. 2, for example, the high pressure mercury lamp 100 includes the luminous bulb 1, in which at least the mercury 6 is enclosed, and the pair of sealing portions 2 for retaining the airtightness of the luminous bulb 1. The amount of the mercury 6 enclosed is at least 230 mg/cm³ (for example, 250 mg/cm³ or more, 270 mg/cm³ or more, or 300 mg/cm³ or more, in some cases, 350 mg/cm³ or more, or 350 to 400 mg/cm³ or more), which amount is determined based on the volume of the luminous bulb.

In the luminous bulb 1, a pair of electrodes (or electrode rods) 3 are opposed to each other. The electrodes 3 are connected, by welding, to respective metal foils 4. The metal foils, which are typically molybdenum foils, are provided in the sealing portions 2. In a case where the high pressure mercury lamp 100 is the lamp 1100 shown in FIG. 2, the metal foils 4 are at least partially positioned in the respective second glass portions 7. External leads 5 are connected to respective ends of the metal foils 4. One of the external leads 5 is connected via a connecting member 63 to an external lead wire 61, and the other external lead 5 is also connected via a connecting member 64 to an external lead wire 62.

The reflector 50 has a reflecting face 50a that has an ellipsoid or a paraboloid. In this embodiment, the reflector 50 is an ellipsoidal mirror having an ellipsoid serving as the reflecting face 50a. An edge portion 50b of the reflector 50 is located around the ellipsoid 50a.

The maximum diameter of the reflecting face 50a of the reflector 50 is for example 45 mm or less. If more downsizing is necessary, it is possible to make the diameter 40 mm or less. The internal volume of the reflector 50 is for example 200 cm³ or less. Exemplary dimensions of the reflector 50 and its focus of this embodiment are as follows: the diameter φ 2 of the reflecting face 50a is about 45 mm, and the depth D of the reflector 50 is about 33 mm. Even if the reflecting face 50a of the reflector 50 is circular in shape when viewed from the front, the reflector-equipped lamp 500 can be rectangular or square in shape when viewed from the front, by using the edge portion 50b. The volume of the reflector 50 of this embodiment is about 40000 mm³, that is, about 40 cc. In a case where the reflector 50 is an ellipsoidal mirror, the distances from the deepest portion of the reflector 50 to focuses F1 and F2 are about 8 mm and about 64 mm, respectively. A front glass may be attached to the first opening 51 of the reflector 50 so that the reflector 50 has a sealed structure.

The structure of the lamp 100 will be explained in further detail. The lamp 100 is composed of the luminous bulb 1 mainly made of quartz glass, and the pair of sealing portions (side tube portions) 2 that extend from both sides of the luminous bulb 1. The lamp 100, which has the two sealing portions 2, is a double-end lamp. The luminous bulb 1, which is substantially spherical, has an outer diameter of for example from about 5 mm to 20 mm, while having a glass thickness of for example from about 1 mm to 5 mm. The volume of a discharge space in the luminous bulb 1 is for example from about 0.01 to 1 cc (0.01 to 1 cm³). The luminous bulb 1 employed in this embodiment has an outer diameter of about 10 mm, a glass thickness of about 3 mm, and a discharge-space volume of about 0.06 cc.

In the luminous bulb 1, the pair of electrode rods 3 are opposed to each other. The electrode rods 3 are disposed in the luminous bulb 1 with their heads being located at a distance (arc length) of about from 0.2 to 5 mm. In this embodiment, the arc length is from 0.5 to 1.8 mm. The lamp employed in this embodiment is operated with alternating current. The sealing portions 2 have a shrink structure formed by a shrinking technique. In the luminous bulb 1, the mercury 6 serving as a luminous species is enclosed in an amount of 230 mg/cc or more, for example. In this embodiment, the mercury 6 is enclosed in an amount of from 270 to 300 mg/cc. Alternatively, the mercury 6 may be enclosed in an amount of 300 mg/cc or more. Furthermore, a rare gas (Ar, for example) at 5 to 40 kPa, and, if necessary, a small amount of halogen are also enclosed. In this embodiment, Ar is enclosed at 20 kPa, and halogen in the form of CH₂Br₂ is introduced into the luminous bulb 1. The amount of CH₂Br₂ enclosed is from about 0.0017 to 0.17 mg/cc. If this amount of CH₂Br₂ is enclosed, halogen atoms are created at a density of from about 0.01 to 1 μmol/cc when the lamp is operated. In this embodiment, halogen atoms are created at a density of about 0.1 μmol/cc. The bulb wall load applied to the inner wall of the luminous bulb during burning is for example 60 W/cm² or more. In this embodiment, the lamp is operated at 120 W and the bulb wall load is about 150 W/cm².

Next, it will be described how a blackening phenomenon occurs in lamps operated at an extremely high operating pressure, and why the temperature of the lower portion 1b of the luminous bulb 1 is desired to be increased.

The fact that lamps become blackened when they are operated at an operating pressure of 30 MPa or more was found by the present inventors for the first time. This is simply because there have been no practically usable lamps having an operating pressure of 30 MPa or more.

Reasons why lamps having an operating pressure of 30 MPa or more become blackened have not yet definitely clarified at present. Since the definite reasons are not known, the present inventors actually attempted various measures and modifications to prevent blackening. For example, it was confirmed that in lamps having an operating pressure of 30 MPa or more, the temperature of the lamps (in particular, of the luminous bulbs) was increased to a higher level as compared to lamps with an operating pressure of from 15 MPa to 20 MPa. The inventors thus suspected that this increase in the luminous bulb temperature might cause a blackening phenomenon, and therefore decreased the luminous bulb temperature by cooling the luminous bulb during burning. However, blackening could not be prevented in this manner. They made various other attempts but failed to prevent blackening well. During their experiments, they increased the temperature of the luminous bulb 1 based on the idea that heating the luminous bulb 1 might work well on the contrary. To their surprise, they succeeded in preventing blackening. Inferring from this successful example, blackening is presumably prevented for the following reason.

In lamps having an operating pressure of 30 MPa or more, the amount of enclosed Hg, a luminous species, is larger than usual. Therefore, electrons released from the electrode collide with Hg atoms more often as compared to lamps having an operating pressure of 20 MPa, and the Hg atoms are thus excited more frequently. In addition, the electron mobility is decreased, so that the arc is narrower than that of the lamps with an operating pressure of 20 MPa. Consequently, the energy per unit volume of the arc is increased, which results in the formation of the arc that has a higher intensity and a higher temperature. Accordingly, the temperature of the heads of the electrodes 3 is elevated, allowing more tungsten to evaporate as compared with the lamps of 20 MPa. Moreover, there are more Hg ions present that are attracted to the cathode to sputter the electrodes. This effect also increases the amount of tungsten evaporated. In other words, in the lamps having an operating pressure of 30 MPa or more, the arc temperature is higher, and the amount of floating Hg and tungsten is larger as compared with the lamps of 20 MPa. Therefore, the resultant convection occurring in the luminous bulb 1 is larger than that in the lamps of 20 MPa, so that more tungsten is carried onto the inner wall of the luminous bulb 1.

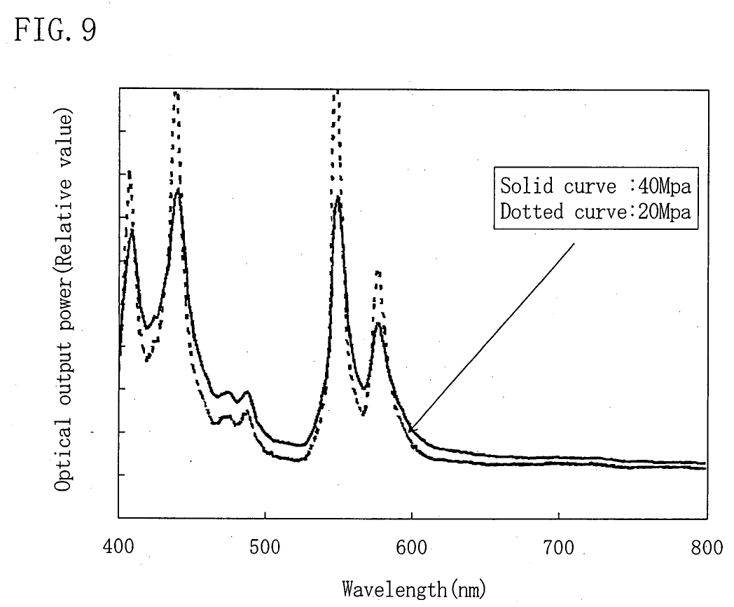

Furthermore, in the lamps having an operating pressure of 30 MPa or more, radiation heat released from the arc is larger than that in the lamps having an operating pressure of 20 MPa, as a result of which thermal balance in the luminous bulb that is maintained in the lamps of 20 MPa collapses. Hereinafter, the collapse of the thermal balance will be discussed with reference to FIG. 9 as well.

FIG. 9 indicates the optical spectra of lamps having operating pressures of 20 MPa and 40 MPa, respectively. As shown in FIG. 9, when the operating pressure is increased, emission of light in the infrared region is also increased. Therefore, radiation heat from the arc is larger in the lamp having the higher operating pressure. The larger radiation heat results in an increase in temperature difference between a region susceptible to the effects of the radiation heat from the arc and a region not susceptible to the effects of the radiation heat. As a result, temperature balance in the luminous bulb that is maintained in the lamps of 20 MPa collapses in the lamps of 30 MPa. Furthermore, the convection in the luminous bulb 1 becomes larger and the heat is thus carried from the lower portion of the luminous bulb 1 to the upper portion thereof, so that the temperature balance also collapses in the upper and the lower portions.

It is inferred that in the lamps of 30 MPa, the above-described state is generated and causes the heat balance to collapse, such that the tungsten attached onto the inner wall of the luminous bulb 1 cannot be returned to the electrodes by the halogen cycle, which leads to the occurrence of blackening. In an experiment that the present inventors carried out, in which the structure of this embodiment was not employed, the temperature difference between the upper and lower portions of the luminous bulb 1 reached even 250 C.°.

It was common knowledge in this field of technology that in high pressure mercury lamps with an operating pressure of from 15 to 20 MPa, the enclosed mercury evaporates completely, and that the lamps exhibits a predetermined operating pressure as expected. However, if the mercury vapor-pressure curve is considered, it might be necessary to return to the knowledge that temperature at a certain level or higher is required to obtain a given operating pressure. That temperature at a certain level or higher is presumably necessary in the operating pressure range exceeding the 20 MPa level. From analysis that the present inventors carried out based on their experiments, it was found that halogen cycles could fail to work well, if the temperature goes below 800 C.°. To achieve an operating pressure of 20 MPa, a temperature of about 800 C.° will be probably necessary, and to attain an operating pressure of 27 MPa, a temperature of about 900 C.° will be probably required.

However, at present, in the field of high pressure mercury lamps (so-called ultrahigh pressure mercury lamps) with an operating pressure of 15 to 20 MPa, attention is being focused on cooling such high pressure mercury lamps having a very high temperature during burning, such that measures to heat further those high-temperature high-pressure mercury lamps have not been taken. In recent years, output power from high pressure mercury lamps has been increasingly raised. If this increase is considered based on the common sense of this field of technology, there is a possibility that scaling up of a reflector and/or adoption of a cold mirror that externally radiates infrared radiation are considered in order to release a large quantity of heat generated by the high pressure mercury lamp. Nevertheless, if these are done, the temperature of the high pressure mercury lamp becomes increasingly lower than the temperature necessary for obtaining a given operating pressure, which might lead to generation of the coldest point in the lamp in spite of the fact that the lamp is the high pressure mercury lamp. A situation in which the temperature of the upper portion 1a of the luminous bulb 1 in the high pressure mercury lamp fail to reach a predetermined temperature will not occur, but the lower portion 1b that has a low temperature in the luminous bulb 1 can be the coldest point.

The present inventors found that blackening of the luminous bulb 1 can be suppressed by heating the luminous bulb 1. However, heating the lamp in the reflector-equipped lamp system to increase the temperature of the lower portion 1b of the luminous bulb 1 to a given temperature or higher within design modifications acceptable for practical products is difficult. Therefore, in the present invention, the microcavities 71 are formed in at least the lower portion 1b of the luminous bulb 1 in the high pressure mercury lamp 100, so that infrared radiation is confined in the microcavities 71 to heat the lower portion 1b of the luminous bulb 1. In this way, only the outer surface of the luminous bulb 1 is surface treated, and such a surface treatment can be carried out easily within the design modifications acceptable for practical products. If the microcavities 71 are formed only in the lower portion 1b of the luminous bulb 1, the infrared radiation passes through the upper portion 1a of the luminous bulb 1, which avoids the problem that the upper portion 1a is heated excessively by the infrared radiation. In addition, the fact that the lower portion 1b is heated makes it possible to positively cool the upper portion 1a for the following reasons. If the microcavities 71 are not formed, positive cooling of the upper portion 1a would result in an unnecessary decrease in the temperature of the lower portion 1b. But with the microcavities 71 formed, such a temperature decrease can be suppressed. If there is no such a problem about the excessively heated upper portion 1a, the microcavities 71 may be formed in the upper portion 1a.

Since lamp power introduced into the high pressure mercury lamp is converted into light and heat, the fact that at least part of the infrared radiation is not released from the high pressure mercury lamp means that part (or most) of the energy corresponding to the unreleased infrared radiation is converted into visible light and ultraviolet light. In other words, the formation of the microcavities 71 also allows the energy efficiency of the visible light to be improved. The microcavities 71 therefore also function to increase the intensity of the emitted visible light.

It is preferable that the diameter of the microcavities 71 be 0.35 μm or greater, because holes of a diameter smaller than 0.35 μm confine light with a wavelength less than 700 nm, thereby decreasing luminous flux coming from the lamp. No upper limit is particularly established. However, quartz glass blocks light with a wavelength of 5 to 6 μm or more, so the microcavities 71 do not have to particularly block the light that the quarts glass blocks. Therefore, it is effective that the diameter of the cavities is 3 μm or less.

In this experiment, blackening was observed in the lamps of 30 MPa or more, but in order to ensure that blackening does not occur for a longer period of time in lamps having an operating pressure of 30 MPa or less but more than 20 MPa (i.e., lamps having an operating pressure exceeding the conventional operating pressure of from 15 to 20 MPa, for example, lamps with an operating pressure of 23 MPa or more, or 25 MPa, or 27 MPa or more), it is practically desirable to employ the structure of this embodiment so as to suppress blackening. In other words, in a case of mass production of lamps, there are inevitably variations in the characteristics of the lamps. Therefore, even among lamps having an operating pressure of the 23 MPa level, one or a few lamps may become blackened, and thus in order to ensure prevention of blackening, it is preferable to use the structure of this embodiment in lamps whose operating pressure exceeds the conventional operating pressure of 15 MPa to 20 MPa. The effects of blackening of course become more significant in lamps having a higher operating pressure. In other words, blacking becomes more significant in lamps whose operating pressure is 40 MPa than in lamps whose operating pressure is 30 MPa. It is thus needless to say that the technical significance of suppressing blackening by the technique of this embodiment is increased, as the operating pressure becomes higher.

In this embodiment, since the microcavities 71 are formed in at least the lower portion 1b of the luminous bulb 1 in the high pressure mercury lamp 100, the lower portion 1b of the luminous bulb 1 can be heated easily. As a result, blackening can be suppressed from occurring even when the high pressure mercury lamp 100 is operated at an operating pressure (for example, 23 MPa or 27 MPa or more), which is even higher than the conventional high operating pressure (for example, 15 to 20 MPa.)

(Second Embodiment)

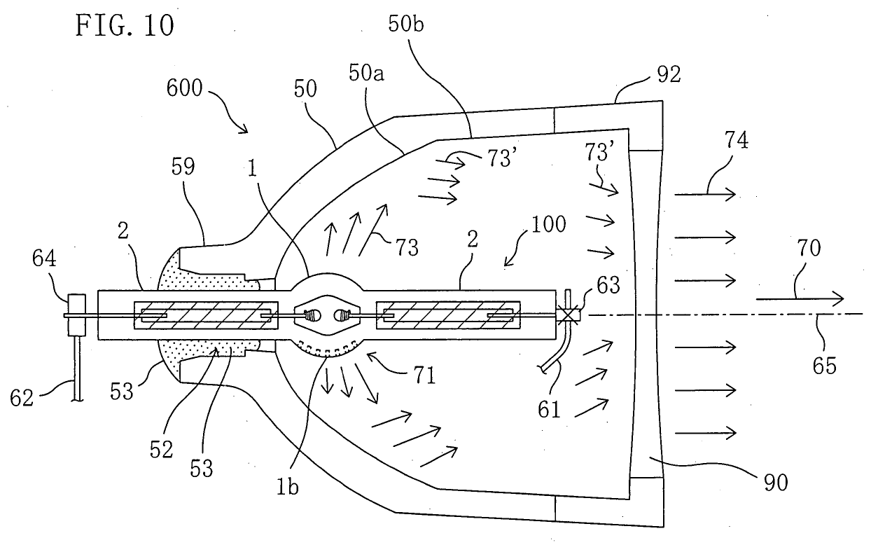

Next, a second embodiment of the present invention will be described with reference to FIG. 10. The structure of this embodiment is a modification of the structure of the first embodiment, and has the same mechanism in which a lower portion 1b of a luminous bulb 1 is heated by microcavities 71.

A reflector-equipped lamp system 600 illustrated in FIG. 10 has a front glass 90 attached forward of a first opening 51 of a reflector 50, and therefore has a substantially sealed structure. Such a substantially sealed structure prevents fragments from going out in case the lamp should break, while functioning to keep an increased temperature inside the reflector-equipped lamp system 600. Since a heating means, which is the microcavities 71, is present in the lower portion 1b of the luminous bulb 1, no particular problems will occur even if a means for positively cooling the upper portion 1a of the luminous bulb 1 is provided, so long as the problem about fragments is solved. In the structure shown in FIG. 10, the front glass 90 is secured to the reflector 50 by a supporting member 92, but may be directly attached to the reflector 50.

In this embodiment, the front glass 90 used is a concave lens, by which the lamp 100 serving as a smaller point light source is substantially realized in the reflector-equipped lamp system 600. This will be described in detail below. When the lamp 100 in the reflector 50 is viewed through the concave lens 90, the lamp 100 looks smaller. This means that the light-emitting point (the light-emitting area where the ark is located) of the lamp 100 substantially becomes small. That is to say, the lamp serving as a smaller point light source is achieved, which is preferable, because as the lamp 100 becomes a smaller point light source, the image projection apparatus can use the light more efficiently.

FIG. 10 indicates a light emission mechanism of the reflector-equipped lamp system 600 in which the reflector 50 is an ellipsoidal mirror. More specifically, light 73 emitted from the luminous bulb (light emitting portion) 1 of the lamp 100 is reflected by the reflecting face 50a of the reflector 50 (as indicated by arrows 73′), and then goes toward the concave lens 90 (more accurately, travels to converge toward the focus), after which the light 73 passes through the concave lens 90 and is emitted as parallel light 74.

In the structure of this embodiment, the concave lens 90 is attached to the reflector-equipped lamp system 600, so that the lamp serving as a smaller point light source can be practically attained, thereby allowing the light to be utilized more efficiently.

It should be noted that the structures and features of the first and second embodiments are mutually applicable to each other as appropriate. Furthermore, blackening of high pressure mercury lamps is a problem that should be avoided in any lamps having an operating pressure exceeding 15 to 20 MPa, which is the operating pressure level of the conventional lamps. Therefore, the techniques of the embodiments of the present invention are not limited to the lamps 1100 to 1500 shown in FIGS. 2 through 5, but are widely applicable to any other lamps having excellent high pressure resistance property, capable of withstanding a high pressure exceeding 20 MPa (e.g., 23 MPa or more, in particular, 27 MPa, or 30 MPa or more).

The blackening phenomenon described in the foregoing embodiments is also affected by the relation between the halogen density and the temperature of the luminous bulb. Therefore, when CH₂Br₂, for example, is selected as halogen to be enclosed, it is preferable to enclose it in an amount of about 0.0017 to 0.17 mg/cc based on the internal volume of the luminous bulb. If this preferable amount is represented in terms of the halogen atom density, about 0.01 to 1 μmol/cc is preferable. This is because if halogen atoms are created at a density smaller than 0.01 t0 1 μmol/cc, most of the halogen reacts with impurities in the lamp, which substantially prevents the halogen cycle from working. On the other hand, if the halogen atoms are produced at a density that exceeds 1 μmol/cc, the pulse voltage necessary for the lamp start-up is increased, making the lamp impractical. However, in a case where a ballast capable of applying high voltage is used, this limitation is not applied. It is more preferable that the halogen atoms be created at a density of 0.1 to 0.2 μmol/cc, because in that case, even if some variations occur in the amount of enclosed halogen due to various situations occurring during fabrication, the halogen cycle can work well in this range.

If the lamp 100 of the foregoing embodiments has a bulb wall load of 80 W/cm² or more, the temperature of the bulb wall of the luminous bulb is increased sufficiently to allow all of the enclosed mercury to evaporate. In that case, the following approximate expression holds: the amount of mercury per internal volume of the luminous bulb: 400 mg/cc=the operating pressure during burning: 40 MPa. If the amount of mercury enclosed is 300 mg/cc, the operating pressure during burning is 30 MPa. On the other hand, if the bulb wall load is less than 80 W/cm², a situation may occur in which the temperature of the luminous bulb cannot be increased to a temperature at which the mercury can evaporate. As a result, the approximate expression may not hold. In the case where the bulb wall load is less than 80 W/cm², a desired operating pressure often cannot be obtained, and in particular, light emission in the infrared region becomes small, and in many cases the lamp is not suitable as a light source for projectors.

The reflector-equipped lamp systems described in the foregoing embodiments may be combined with an optical system that includes an image device (such as a digital micromirror device (DMD) panel or a liquid crystal panel), to form an image projection apparatus. For example, projectors (digital light processing (DLP) projectors) using DMDs, and liquid crystal projectors (including reflective projectors using a liquid-crystal on silicon (LCOS) structure) can be provided. Furthermore, the lamps of this embodiment may be suitably used not only as a light source for an image projection apparatus but also for other applications such as a light source for an ultraviolet radiation stepper, a light source for a sport stadium, a light source for an automobile headlight, and a floodlight for illuminating traffic signs.

In the foregoing embodiments, mercury lamps employing mercury as luminous material are described as exemplary high pressure discharge lamps, but the present invention may be applied to any metal halide lamps having the structure in which sealing portions (seal portions) retain the airtightness of the luminous bulb. The metal halide lamps are high pressure discharge lamps in which a metal halide is enclosed. In recent years, mercury free metal halide lamps, in which no mercury is enclosed, have been also under development, and the present invention can be also applied to those mercury free metal halide lamps.

Exemplary mercury free metal halide lamps have a structure shown in FIG. 6, for example, in which substantially no mercury but at least a first halide, a second halide, and a rare gas are enclosed in the luminous bulb 1. In such lamps, the metal constituting the first halide is a luminous material. The second halide, which has a higher vapor pressure than the first halide, is a halide of one or more metals that emit light in the visible region with more difficulty than the metal constituting the first halide. For example, the first halide is a halide of one or more metals selected from the group consisting of sodium, scandium, and rare earth metal. The second halide has a relatively higher vapor pressure and is a halide of one or more metals that emit light in the visible region with more difficulty than the metal constituting the first halide. More specifically, the second halide is a halide of at least one metal selected from the group consisting of Mg, Fe, Co, Cr, Zn, Ni, Mn, Al, Sb, Be, Re, Ga, Ti, Zr, and Hf. The second halide preferably contains at least a Zn halide.

Another exemplary combination is as follows. In a mercury-free metal halide lamp including a translucent luminous bulb (airtight vessel) 1, a pair of electrodes 3 provided in the luminous bulb 1, and a pair of sealing portions 2 coupled to the luminous bulb 1, SCI₃ (scandium iodide) and NaI (sodium iodide) as luminous materials, InI₃ (indium iodide) and TlI (thallium iodide) as alternative materials to mercury, and a rare gas (e.g., a Xe gas at 1.4 MPa) as a starting aid gas are enclosed in the luminous bulb 1. In this case, ScI₃ (scandium iodide) and NaI (sodium iodide) constitute the first halide, while InI₃ (indium iodide) and TlI (thallium iodide) constitute the second halide. The second halide may be any halide so long as the halide has a comparatively high vapor pressure and can serve as an alternative to mercury. Therefore, Zn iodide, for example, may be used instead of InI₃ (indium iodide) and the like.

While the present invention has been explained in several forms as described in the preferable embodiments thereof, it is not so limited but susceptible of various changes and modifications.

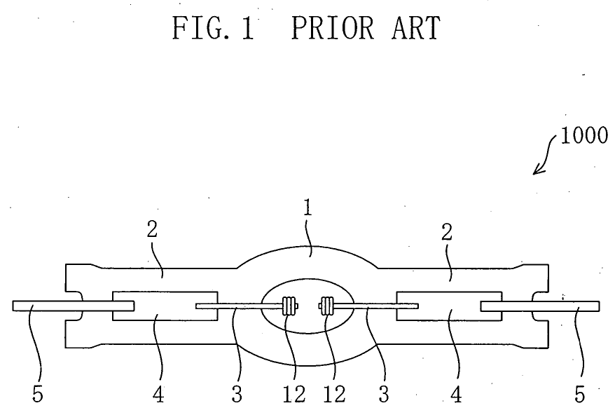

Regarding the lamp (see FIG. 1) disclosed in Japanese Laid-Open Patent Publication No. 2-148561, the publication describes that the Hg vapor pressure thereof is 200 to 350 bars (corresponding to about 20 to about 35 MPa). However, examinations carried out by the present inventors made it clear that if lamps of this type are operated at an operating pressure of 30 MPa or more, several tens or more percent of the lamps break within the first six hours of burning. If those lamps are operated for 2000 hours, which are required for lamps on a practical level, more of the lamps will presumably break. It will be therefore difficult in reality for the lamps having the structure shown in FIG. 1 to achieve an operating pressure of 30 MPa or more on the practical level.

According to the present invention, since microcavities are formed in at least the lower portion of a luminous bulb, the lower portion of the luminous bulb can be heated easily. As a result, blackening can be suppressed in high pressure discharge lamps whose operating pressure exceeds 20 MPa (for example, 23 MPa or more, in particular 25 MPa or more (or 27 MPa or more, or 30 MPa or more)).

What is claimed is:

1. A lamp system with a reflector, comprising:
a high pressure discharge lamp including a luminous bulb with a luminous substance enclosed therein and a pair of sealing portions extending from the luminous bulb, and
a reflector for reflecting light emitted from the high pressure discharge lamp,
wherein the reflector has a first opening located in a forward position of the reflector with respect to a light-emission direction, and the reflector is formed with a second opening into which one of the sealing portions is inserted,
at least one of the sealing portions has a first glass portion extending from the luminous bulb and a second glass portion provided in at least a portion inside the first glass portion, and the at least one sealing portion has a portion to which a compressive stress is applied, and
when the sealing portions are disposed in a substantially horizontal direction, a microcavity is formed in at least a lower portion of the luminous bulb.

2. The lamp system of claim 1, wherein the high pressure discharge lamp is a high pressure mercury lamp, and
mercury is enclosed as the luminous substance in an amount of 230 mg/cm³ or more based on the internal volume of the luminous bulb.

3. A lamp system with a reflector, comprising:
a high pressure mercury lamp including a luminous bulb with at least mercury enclosed therein and a pair of sealing portions extending from the luminous bulb, and
a reflector for reflecting light emitted from the high pressure mercury lamp,
wherein the reflector has a first opening located in a forward position of the reflector with respect to a light-emission direction, and the reflector is formed with a second opening into which one of the sealing portions is inserted,
each of the sealing portions has a first glass portion extending from the luminous bulb and a second glass portion provided in at least a portion inside the first glass portion, and each of the sealing portions has a portion to which a compressive stress is applied, and
when the sealing portions are disposed in a substantially horizontal direction, a microcavity, which at least partially blocks infrared radiation emitted outward from inside the luminous bulb, is formed in at least a lower portion of an outer surface of the luminous bulb.

4. The lamp system of claim 1, wherein the portion of the luminous bulb in which the microcavity is formed blocks transmission of infrared radiation, while passing visible light, and
the other portion of the luminous bulb in which the microcavity is not formed passes both the infrared radiation and the visible light.

5. The lamp system of claim 3, wherein the portion of the luminous bulb in which the microcavity is formed blocks transmission of infrared radiation, while passing visible light, and
the other portion of the luminous bulb in which the microcavity is not formed passes both the infrared radiation and the visible light.

6. The lamp system of claim 1, wherein the microcavity has a diameter of 0.35 μm or greater.

7. The lamp system of claim 3, wherein the microcavity has a diameter of 0.35 μm or greater.

8. The lamp system of claim 1, wherein the microcavity is formed in the lower portion of the luminous bulb and is not formed in an upper portion of the luminous bulb.

9. The lamp system of claim 3, wherein the microcavity is formed in the lower portion of the luminous bulb and is not formed in an upper portion of the luminous bulb.

10. The lamp system of claim 1, wherein at least mercury is enclosed as the luminous substance,
the amount of the enclosed mercury is 270 mg/cm³ or more based on the internal volume of the luminous bulb,
halogen is enclosed in the luminous bulb, and
the lamp has a bulb wall load of 80 W/cm² or more.

11. The lamp system of claim 3, wherein at least mercury is enclosed as the luminous substance,
the amount of the enclosed mercury is 270 mg/cm³ or more based on the internal volume of the luminous bulb,
halogen is enclosed in the luminous bulb, and
the lamp has a bulb wall load of 80 W/cm² or more.

12. The lamp system of claim 10, wherein the mercury is enclosed in an amount of 300 mg/cm³ or more based on the internal volume of the luminous bulb.

13. The lamp system of claim 11, wherein the mercury is enclosed in an amount of 300 mg/cm³ or more based on the internal volume of the luminous bulb.

14. The lamp system of claim 1, wherein a pair of electrode rods are opposed to each other in the luminous bulb,
the electrode rods are connected to respective metal foils, and
the metals foils are provided in the respective sealing portions, and at least partially positioned in the respective second glass portions.

15. The lamp system of claim 3, wherein a pair of electrode rods are opposed to each other in the luminous bulb,
the electrode rods are connected to respective metal foils, and
the metals foils are provided in the respective sealing portions, and at least partially positioned in the respective second glass portions.

16. The lamp system of claim 14, wherein a coil at least the surface of which has at least one metal selected from the group consisting of Pt, Ir, Rh, Ru, and Re is wound around at least a part of each of the electrode rods where the electrode rods are buried in the sealing portions.

17. The lamp system of claim 15, wherein a coil at least the surface of which has at least one metal selected from the group consisting of Pt, Ir, Rh, Ru, and Re is wound around at least a part of each of the electrode rods where the electrode rods are buried in the sealing portions.

18. The lamp system of claim 1, wherein a metal portion that is in contact with the second glass portion and supplies power is provided in each of the sealing portions,
the compressive stress is applied in at least a longitudinal direction of the sealing portions,
the first glass portion contains 99 wt % or more of SiO₂, and
the second glass portion contains SiO₂ and at least one of 15 wt % or less of Al₂O₃ and 4 wt % or less of B.

19. The lamp system of claim 3, wherein a metal portion that is in contact with the second glass portion and supplies power is provided in each of the sealing portions,
the compressive stress is applied in at least a longitudinal direction of the sealing portions,
the first glass portion contains 99 wt % or more of SiO₂, and
the second glass portion contains SiO₂ and at least one of 15 wt % or less of Al₂O₃ and 4 wt % or less of B.

20. The lamp system of claim 1, wherein when the sealing portions are measured by a sensitive color plate method utilizing the photoelastic effect, the compressive stress in a region corresponding to the second glass portion is from 10 kgf/cm² to 50 kgf/cm² inclusive.

21. The lamp system of claim 3, wherein when the sealing portions are measured by a sensitive color plate method utilizing the photoelastic effect, the compressive stress in a region corresponding to the second glass portion is from 10 kgf/cm² to 50 kgf/cm² inclusive.

22. A lamp system with a reflector, comprising:
a high pressure mercury lamp including a luminous bulb with at least mercury enclosed therein and a pair of sealing portions extending from the luminous bulb, and
a reflector for reflecting light emitted from the high pressure mercury lamp,
wherein the reflector has an opening located in a forward position of the reflector with respect to a light-emitting direction,
in the luminous bulb of the high pressure mercury lamp, the mercury is enclosed in an amount of 230 mg/cm³ or more based on the internal volume of the luminous bulb,
the high pressure mercury lamp has a bulb wall load of 80 W/cm² or more, and
when the sealing portions are disposed in a substantially horizontal direction, a microcavity is formed in at least a lower portion of the luminous bulb.

23. A high pressure discharge lamp comprising:
a luminous bulb, in which at least mercury is enclosed, and
a sealing portion extending from the luminous bulb,
wherein the mercury is enclosed in the luminous bulb in an amount of 230 mg/cm³ or more based on the internal volume of the luminous bulb, and
a microcavity is formed in at least a portion of the luminous bulb.

24. A lamp system with a reflector, comprising:
a luminous bulb, in which at least mercury is enclosed, and
a pair of sealing portions extending from the luminous bulb,
wherein each of the sealing portions has a first glass portion extending from the luminous bulb and a second glass portion provided in at least a portion inside the first glass portion, and each of the sealing portions has a portion to which a compressive stress is applied, and
a microcavity, which at least partially blocks infrared radiation emitted outward from inside the luminous bulb, is formed in at least a portion of an outer surface of the luminous bulb.

25. An image projection apparatus comprising:
the reflector-equipped lamp system of claim 1, and
an optical system in which the reflector-equipped lamp system is used as a light source.

26. An image projection apparatus comprising:
the reflector-equipped lamp system of claim 3, and
an optical system in which the reflector-equipped lamp system is used as a light source.

27. An image projection apparatus comprising:
the reflector-equipped lamp system of claim 22, and
an optical system in which the reflector-equipped lamp system is used as a light source.

28. An image projection apparatus comprising:
the reflector-equipped lamp system of claim 24, and
an optical system in which the reflector-equipped lamp system is used as a light source.
